(19) United States
(12) Patent Application Publication
(10) Pub. No.: US 2024/0095651 A1
(43) Pub. Date: Mar. 21, 2024

(54) SYSTEM AND METHOD FOR UNMANNED OR UNDERMANNED DELIVERY OF RESTRICTED PRODUCTS

(71) Applicant: BizBoxes, LLC, Phoenix, AZ (US)

(72) Inventor: Jon Patrick Hurry, Phoenix, AZ (US)

(21) Appl. No.: 18/274,339

(22) PCT Filed: Oct. 13, 2021
(86) PCT No.: PCT/US2021/054653

§ 371 Date: Jul. 26, 2023

Related U.S. Application Data
(60) Provisional application No. 63/090,809, filed on Oct. 13, 2020.
(60) Provisional application No. 63/125,510, filed on Dec. 15, 2020.
(60) Provisional application No. 63/146,296, filed on Feb. 5, 2021.

(51) Int. Cl. G06Q 10/0832; G06Q 20/40; G06Q 30/0601

(52) U.S. Cl. CPC G06Q 10/0832; G06Q 20/403; G06Q 30/0607; G06Q 10/087

(57) ABSTRACT

A system and method for delivering restricted products. The delivery system may include a user device, an external server, and a delivery unit. A user can register to use the system by verifying their identity and recording at least one biometric characteristic with the user device. When a user selects a restricted product for purchase at the delivery unit, the user's identity may be verified, the user's presence at the delivery unit may be verified through a liveness check and/or a location determination, the user's eligibility to purchase the selected product may be determined, and the user's ability to pay for the selected products may be determined. If the external server determines the user is eligible to purchase the selected product, the external server can send a delivery command to the delivery unit and the delivery unit may allow the user to have access to the purchased product.

### BACKGROUND OF THE INVENTION

The present invention relates to a system and method for unmanned or undermanned delivery of restricted products.

Vending machines are common in certain areas, but have had limited applicability in the sale of restricted items including restricted substances. For example, vending machines are not as readily available for age restricted products (i.e. tobacco, alcohol, recreational marijuana) and products that have licenses, permits, and/or prescriptions to allow a person to access them (i.e. prescription drugs and medical marijuana).

Selling controlled substances traditionally involves someone of legal age being present to verify a prospective consumer's age and eligibility, which means a business selling a controlled substance has a staff member available to do so at all times the controlled substance(s) are available for purchase. This can be an expensive endeavor. Vending machines have been used to sell some restricted items in locations where the consumer's ability to purchase the products has already been verified. For example, vending machines for tobacco can be found in bars where the patron's age was verified on entry and marijuana vending machines may be found in dispensaries where the patron's age and/or medical marijuana card was verified on entry. Such vending machines are simple machines that dispense the selected item without an identity verification step. Put another way, the vending machines are “dumb;” they are unaware of the status of their customers as the verification step was performed elsewhere. These vending machines also do not maintain transactional data. Many of these systems utilize at least some contact between the user and the vending device

Additionally, the increased desire for convenience and focus on sanitation for high-touch surfaces have made traditional vending machines less appealing. A vending machine may have one or more high-touch surfaces that people are inclined to avoid contact with where possible in order to avoid contact with any bacteria or viruses living on those surfaces.

### SUMMARY OF THE INVENTION

In one aspect, a delivery system for restricted products may include a user device, a delivery unit, and an external server. The user device may include an input device and a user communication module. The input device can be configured to receive information from a user. The delivery unit may contain at least one restricted product, and may include a restriction mechanism and a delivery communication module. The restriction mechanism can be configured to prevent access to at least one restricted product until a delivery command is received. The external server may include a server communication module. The external server can be communicatively coupled to the user device and the delivery unit.

The external server may communicate with the delivery unit to determine an inventory of the delivery unit and communicate the inventory to the user device. The user device can receive a user input via the input device of at least one selected product from the inventory. The user device may communicate the at least one selected product and a user identifier to the external server. The external server can calculate a location determination of whether the user device is within a predefined geographic range of the delivery unit. The external server may calculate a verification determination of the user's identity based on the user identifier and at least one pre-registered user characteristic. The external server can calculate an eligibility determination of whether the user is eligible to purchase the selected product based on at least one characteristic of the at least one selected product and the user identifier. The external server may calculate a payment determination of whether the user has a sufficient amount of funds to pay for the at least one selected product. The external server may send the delivery command to the delivery unit based on the location determination, the verification determination, the eligibility determination, and the payment determination. After receiving the delivery command, the delivery unit can provide access to the at least one selected product.

In one aspect, the restricted products may include at least one of a restricted good and a restricted service.

In one aspect, the user identifier can include at least one piece of biometric information. The biometric information may be a facial scan, a fingerprint scan, a palm scan, a retina scan, and/or an at least one vocal characteristic.

In one aspect, the user device can communicate a user device location to the external server. The delivery unit may communicate a delivery unit location to the external server. The external server can calculate the location determination based on the user device location and the delivery unit location.

In one aspect, if the user device and the delivery unit are both communicating on a communication network, the external server can calculate the location determination based on the communication network.

In one aspect, the system can include an identification database communicatively coupled to the external server. The external server may calculate the verification determination by communicating with the identification database.

In one aspect, the system can include a restriction database communicatively coupled to the external server. The external server may calculate the eligibility determination by communicating with the identification database.

In one aspect, the delivery unit may append a label to at least one of the at least one selected products after receiving the delivery command and before providing access to the at least one selected product. In one aspect, the label can include at least one of an access date, an access time, and an access location.

In one aspect, the external server may calculate an overly intoxicated determination based on the user identifier and at least one pre-registered user characteristic. The external server can send a delivery command to the delivery unit based on the overly intoxicated determination, the location determination, the verification determination, the eligibility determination, and the payment determination.

In one aspect, a method of registering for a delivery system for restricted products is described. A phone application can be accessed from a user device. The user device may capture a front and a back of an identification and may send the front and back of the identification to the external server. The user device can capture at least one biometric information of a user and send it to the external server. The user device may receive a payment information from a user and may send the payment information to the external server. The external server may calculate a verified identity of the user based on at least one of the front of an identification, the back of an identification, the at least one biometric information, and the payment information. The external server can store the verified identity of the user.

In one aspect, the external server can calculate the verified identity through communication with an identification database. In one aspect, the identification database is external to the system.

In one aspect, the external server may send an error message to the user device if the verified identity could not be calculated. The user device can display the error message in the phone application.

In one aspect, a method for purchasing a restricted product from a delivery system for restricted products is described. An external server may receive an inventory from a delivery unit and may send the inventory to a user device. The user device can display the inventory. The user device may receive a selection of at least one restricted product from the inventory from a user and may send the selection and a user identifier to the external server. The external server can calculate a location determination of whether the user device is within a predefined geographic range of the delivery unit. The external server may calculate a verification determination of the user's identity based on the user identifier and at least one pre-registered user characteristic. The external server can calculate an eligibility determination of whether the user is eligible to purchase the selection based on at least one characteristic of the selection and the user identifier. The external server may calculate a payment determination of whether the user has a sufficient amount of funds to pay for the at least one selected product. The external server can send a delivery command to the delivery unit based on the location determination, the verification determination, the eligibility determination, and the payment determination. The delivery unit may provide access to the selection after receiving the delivery command.

In one aspect, the external server may calculate the eligibility determination by communicating with a restriction database.

Before the aspects of the invention are explained in detail, it is to be understood that the invention is not limited to the details of operation or to the details of construction and the arrangement of the components set forth in the following description or illustrated in the drawings. The invention may be implemented in various other aspects and may be practiced or may be carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various aspects. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is an overview of a restricted product delivery system according to one aspect.

FIG. 2 is an overview of a restricted product delivery system according to one aspect.

FIG. 3 is a process for operating a restricted product delivery system according to one aspect.

FIGS. 4A-4B are a portion of a restricted product delivery system according to one aspect.

FIG. 5 is a process for restricted product delivery according to one aspect.

FIG. 6 is a registration process for a restricted product delivery system according to one aspect.

FIG. 7 is an exemplary method for using a restricted product delivery system according to one aspect.

### DETAILED DESCRIPTION OF THE CURRENT ASPECTS

A system and method for unmanned or undermanned delivery of restricted products according to various aspects is shown and described herein.

The restricted product delivery system may be an unmanned or undermanned system that restricts access to products until the prospective purchaser has been verified. The terms verify and authenticate are used interchangeably throughout the specification. The restricted product delivery system can account for the local, state, and federal laws and regulations for selling restricted products without the supervision of a person or with minimal supervision. The type of restricted product may dictate the type(s) of verification needed for purchase. For example, alcohol, tobacco, cannabis, over the counter (“OTC”) drugs, prescription drugs, guns, and ammunition are all age restricted, and, in some cases, have limitation on how much can be purchased and how often they can be purchased. In one aspect, the previously mentioned products cannot be sold to someone who is overly intoxicated. In one aspect, the previously mentioned products may be subject to other controls such as not being available for purchase by persons listed in a certain disqualifying database. The restricted product delivery system can utilize a phone application and an external server to authenticate the user, determine the user's eligibility, and deliver a restricted product. In one aspect, the determination of the user's eligibility may be referred to as an eligibility determination. In one aspect, the restricted product delivery system may access partner technologies and third-party databases to authenticate the user. In one aspect, the user's eligibility can be based on at least one of the laws, regulations, and regulatory suggestions applicable to the area in which the delivery unit is located; local preferences; and retailer, vendor, or venue preferences. The restricted product delivery system may be complimentary to and synergistic with third-party control or restriction systems, such as a convictions database.

The following definitions may be used throughout the specification.

A restricted product may be defined as any good or service to which access is limited in some way. A product can be restricted according to any criteria such as age, product or substance quantity, status (for example, having been convicted of a felony or being under psychiatric care may prevent a person from purchasing guns or ammunition). A product may be subject to controls from a number of sources, for example, government or agency laws and regulations. For example, a customer has to have a prescription to access prescription drugs. In another example, a customer has to be of a certain age (i e minimum 18 years old) to participate in gambling at a slot machine. A restricted product may alternately be referred to as a controlled product.

A delivery unit can be defined as any device that restricts and provides access to restricted products. Put another way, a delivery unit may be any equipment that has the ability to lock and control dispensing of products through any type of communication mechanism. The delivery unit can deliver products purchased by the user. In one aspect, the delivery unit may be unmanned. In one aspect, the delivery unit can be undermanned. The delivery unit can include a restriction mechanism that prevents the user from accessing the restricted products until a delivery command is received. For example, in one aspect, the restriction mechanism may be a lock, a door, or a software-based control. Some exemplary delivery units include vending equipment (such as vending machines), drones (both aerial and ground based), checkout lanes, kiosks, lockers, and dispensing boxes. A dispensing box may be defined as a locker that is loaded from the back side instead of the front (user facing) side. The floor of the individual locker in the dispensing box can tilt forward and the product may slide to an open area under the box for retrieval by the user.

An undermanned delivery system may be defined as a delivery system that allows a user to complete a purchase with minimal oversight (for example, either physical oversight or via a video feed). For example, a system that allows multiple people to purchase products using multiple source with only one person overseeing activities centrally may be an undermanned system.

An unmanned delivery system can be defined as a delivery system that allows a user to complete a purchase without any physical or video oversight or human interaction.

A touchless delivery unit can be defined as one in which the customers do not have to touch the device to receive the product. For example, in the context of a kiosk, vending machine, or locker, the customer does not touch any part of the device to receive the product, not even the door. This can reduce or eliminate the sanitization of surfaces because the surfaces of the device are not being touched and thus are not being used to spread bacteria or viruses. A touchless delivery unit may be said to provide touchless delivery of a product. In one aspect, users may interact with a touchless delivery unit through a cell phone application (also known as a phone application or application) or voice commands. When a cell phone application is used to access the delivery unit, the user may place an order through the phone and a transaction code can be issued back to the phone to indicate that the transaction is verified. The code may be presented to the delivery unit to instruct the delivery unit on which product to provide access to. The phone application can present the code to the delivery unit by transmitting the code through a suitable communication protocol (i.e. BLUETOOTH or WiFi) or by showing the code (i.e. a quick response (“QR”) code or barcode) to a scanner or camera on the delivery unit. Biometrics can also be used to securely verify the user's identity using the camera, phone application, and/or the touch screen before purchase. In one aspect, the delivery unit can automatically open a door to provide access to the product or automatically dispense the product once verification is complete.

Phone Biometric Options may be defined as using a cell phone (or other user device for a biometric scan or multi-factor identification. In one aspect, the user device may also be used for ordering the restricted product

A biometric scan can refer to a scan of a user's unique human characteristics to verify their identity. Biometric scans may include retina scans, facial scans, finger print scans, or a scan of any other unique feature of an individual. For example, this can include electrical signals emitted by a person or magnetic waves as each individual has a different electric field, magnetic field, or emissivity. In one example, a user may be prompted to center their face in the camera or move their head in or out for the user device to complete a facial scan.

A phone order notification can be a notification to the customer that the requested product is ready to be picked up at a delivery unit. The phone order notification may be text messaged, emailed, and/or sent through a cell phone app. The phone order notification may identify that the product is ready to be picked up, where the product is (i.e. the location of the touchless device), and, if applicable, the locker number in which the goods are located.

A phone application may be defined as a cell phone application that is optionally used to coordinate all aspects of the transaction. In one aspect, the phone application may incorporate payment through an online credit card or a reserved credit. In one aspect, the phone application may obtain and utilized biometric approval information or multi-factor identification. In one aspect, the phone application can include location information for vending machines, kiosks, and lockers, and available products in the devices and their associated costs.

Multi-factor authentication may refer to the confirmation of a piece of information (e.g. a user's identity) through two or more authentication methods. Some exemplary authentication methods include a code sent through a service (such as a phone application, email service, social media platform, etc.), driver's license, credit card, passport, identification card, and biometric identification.

Overly intoxicated may be defined as a level of intoxication above legal intoxication at which the person who is overly intoxicated is ineligible to purchase certain restricted products. For example, overly intoxicated may be defined as two to three times the legal intoxication amount. Put another way, overly intoxicated can be defined as a person who is so intoxicated that they do not having the ability to function within the norms of society. For example, many laws prevent the sale of alcohol, cannabis, and other substances to persons who are overly intoxicated. Overly intoxicated may alternately be referred to as unduly intoxicated or overly impaired.

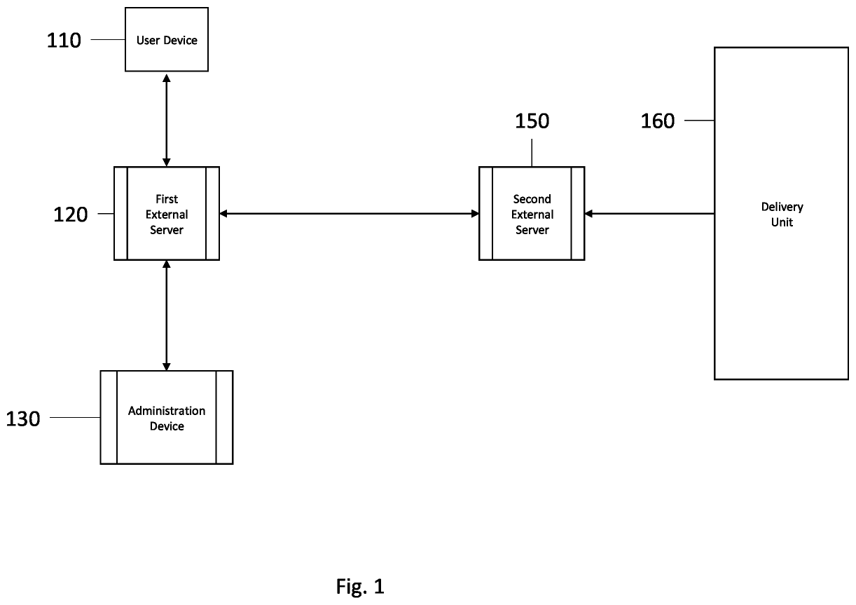

FIG. 1 shows a restricted product delivery system 100 according to one aspect. The restricted product delivery system may include a user device 110, a first external server 120, an administration device 130, a second external server 150, and a delivery unit 160. The user device 110 may have a phone application installed to provide access to the restricted product delivery system 100. The user device can include an input device that may be used to receive an input from a user. For example, in one aspect, the input device can be a touch screen or a microphone to receive a voice command. In one aspect, the phone application and the first external server 120 may be described as a Software as a Service (“SaaS”) platform. The user device 110 and the administration device 130 can be communicatively coupled to the first external server 120. In one aspect, the user device 110 and the first external server 120 can be integrated into one component. All communication between components can use any suitable communication language and protocol. The administration device 130 may perform a variety of functions. For example, the administration device 130 may provide inventory management. In another example, the administration device 130 may virtually turn off the delivery unit 160, either at a predetermined time or upon the occurrence of an event. The first external server 120 may be communicatively coupled to the second external server 150. In one aspect, the first external server 120 and the second external server 150 may communicate using Rest, GraphQL, XML web services, or any other suitable communication method. The delivery unit 160 may be communicatively coupled to the second external server 150. In one aspect, the delivery unit 160 and the second external server 150 may be integrated into one component.

Each of the user device 110, the first external server 120, the administration device 130, the second external server 150, and the delivery unit 160 may include one or more microcontrollers, microprocessors, and/or other programmable electronics that are programmed to carry out various functionality, which are described herein. The system 100 may additionally or alternatively include other electronic components that are programmed to carry out the functions described herein, or that support the microcontrollers, microprocessors, and/or other electronics. The other electronic components can include, but are not limited to, one or more field programmable gate arrays, systems on a chip, volatile or nonvolatile memory, discrete circuitry, integrated circuits, application specific integrated circuits (ASICs) and/or other hardware, software, or firmware. Such components can be physically configured in any suitable manner, such as by mounting them to one or more circuit boards, or arranging them in another manner, whether combined into a single unit or distributed across multiple units. Such components may be physically distributed in different positions in the system 100, or they may reside in a common location within the system 100. The components may communicate using any suitable communication protocol and hardware.

In one aspect, a restricted product delivery system may include a delivery unit, a verification system, and a user device. The delivery unit can be a stand-alone device in any type of location with reduced employee supervision (i.e. an undermanned system). In one aspect, the restricted product delivery system may entirely unmanned. The delivery unit can restrict access to one or more restricted products (e.g. a controlled substance). The verification system may utilize biometrics or multi-factor authentication for verifying a prospective purchaser's purchasing availability. When the user's identity is verified, the process may be referred to as a verification decision. In one aspect, the user device may communicate with the delivery unit for touchless delivery of products. The verification system may be incorporated in an external server. The external server can be in the same location as the delivery unit, or the external server can be in a remote location. The external server may be updated through the internet, via a secure server, or through any other suitable method.

In one aspect, a user may solely interact with the delivery unit through a user device (e.g. a cellular telephone). A delivery phone application can be installed on the user device. The delivery phone application may allow the user to register to use the delivery system. Registration may involve the user registering their biometrics using the phone's camera, finger or palm print scanner or other sensor, microphone to perform voice recognition, or any other biometrics. Registration can also include a user uploading their government identification (such as through a picture or a scan). The phone application may verify the government identification with the issuing agency. If the registration includes multiple authentication methods, then multi-factor authentication may be used to provide access to the delivery unit. For example, the multi-factor authentication can use one or more biometric identifiers and a credit card registered with the phone application to verify the user through multiple methods.

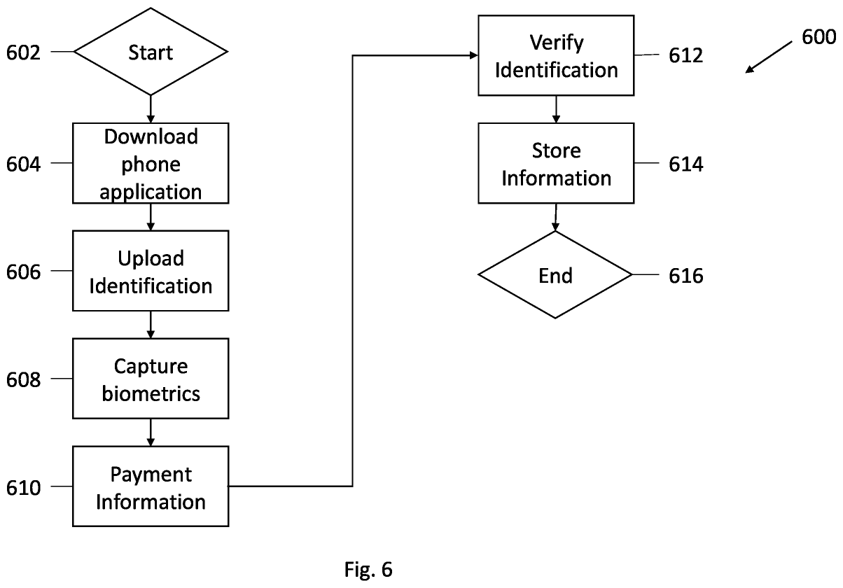

One exemplary registration process 600 to use the delivery system is shown in FIG. 6. The method begins at Step 602 with the user downloading the phone application to the user device. The user may then upload their government-issued identification to the phone application. Step 604. In one aspect, this may involve the user taking a picture of the front and back of their identification (such as a driver's license, passport, or state or country identification). The user can then use the user device to capture their biometrics. Step 608. In one aspect, the user's biometrics may be referred to as a pre-registered user characteristic. The phone application may be configured to capture any number of biometrics. In one aspect, the phone application can capture the user's face by prompting the user to hold the user device up to their face and scanning their face; voice by prompting the user to speak a sentence or key words into the user device; and finger prints or palm on one or both hands by prompting the user to perform a fingerprint or palm scan using a sensor or camera on the user device. In one aspect, the phone application may ask the user to read a phrase that can be used as a baseline for voice analysis. The phone application may ask the user to repeat the same phrase multiple times and/or to read multiple phrases one or more times. The user's information may be vetted against a database to verify the user is the same person as shown in the identification. This database may be referred to as an identification database. In one aspect, the phone application may capture the user's cognitive response. For example, the user may be asked several simple math questions which are used to monitor cognitive performance A user's cognitive response may utilize an analysis of the speed and accuracy with which the user responds to simple questions. In one aspect, the user's cognitive response may be referred to as a pre-registered user characteristic. In one aspect, the user's cognitive response can be combined with their speech characteristics. For example, the user may be asked to provide a verbal response to the question “What is 11+66?” In one aspect, the phone application can capture the user's liveness test information. In one aspect, the liveness test information may be captured by prompting the user to move their head or eyes to the left, right, up, or down.

The user can enter payment information into the phone application. Step 610. The payment information may be any suitable payment method including, for example, a credit card, debit card, or APPLE PAY. The phone application may verify the user's identification through the issuing agency. Step 612. This can involve the phone application communicating with a third-party service. The user's information may then be stored by the phone application. Step 614. In one aspect, the user's information may be stored in the phone application or otherwise on the user device itself. In an alternate aspect, the user's information can be stored in an external server, which may be based in hardware or cloud computing. For example, the user's age can be stored and automatically updated. In another example, the user's purchase information may be stored. This information can be used to track how much of a controlled product (for example, marijuana or cold medicine) is purchased by the user in a given period of time. In one aspect, the system may limit the amount of a controlled product a user can purchase. In one aspect, the phone application may report the amount the user has purchased in a given period of time to an external database (either directly or through the external server). In one aspect, the user's purchase information can be tracked and accumulated to better understand individual purchasing habits and preferences. In one aspect, the system may limit the amount of a controlled substance a user can purchase. The amount of the controlled substance may vary across different products.

In one aspect, the registration process may include asking the user for their contact information (i.e. a phone number or email address). This information can be used in a variety of ways. For example, it may be used to send receipts for completed transactions to the user. In one aspect, the user may be prompted to accept terms and conditions during the registration process as a condition of registration.

Once registration is completed, a background check may be completed to verify the identification of the application user. In one aspect, the background check can involve consulting a third-party database to verify the user's identity. For example, the system may communicate with a government database to ensure the presented identification is valid and that the user is the person on the identification. In one aspect, the third-party database may be an identification database. The user's identity, age, and any restrictions that are accessible to the system through access to controls (such as the pseudoephedrine database) can be loaded into a user profile.

In one aspect, the restricted product delivery system may include a determination that the user is not overly intoxicated. This may be referred to as an overly intoxicated determination. This determination may utilize biometric and/or observational data. In one aspect, the user device can complete a statistical comparison of the user's typical characteristics with their currently exhibited characteristics to determine whether the user is overly intoxicated. The user's typical characteristics may be recorded at verification or may be monitored over time after the phone application has been installed on the user device. Some exemplary characteristics are slurred speech (using the microphone on the user device); change in stride, such as a different pace, gate, or unexpected stagger (using an accelerometer on the user device); facial sag (using the camera on the user device); and dilated pupils or droopy eyelids (using the camera on the user device). In one aspect, the facial sag, dilated pupil, and droopy eyelid data may only be collected while the user is using the phone application. All of the observations for intoxication are a result of observing normal behavior or behavior when you registered for app to the behavior right before purchase. If anomalies are detected, the phone application may prompt the user to perform additional screening. For example, the phone application can instruct the user to read a phrase that the user read during registration and can compare the two results to make a statistical determination of whether the person is overly intoxicated.

A determination that the user is overly intoxicated may inhibit their ability to purchase certain products. For example, an overly intoxicated user can be prevented from purchasing alcohol. An over intoxication determination may be able to alert the user that they should not perform certain tasks, such as driving or going to work. The phone application may detect over intoxication on any substance or industrial fumes. In one aspect, an over intoxication determination can be an indicator that the user is suffering from a medical disorder, such as a stroke.

The phone application can begin to build data profiles for the user by collecting data, for example, accelerometer data from the user device, and voice data (for example, pitch, tone, resonance, speed, and clarity/slurring). In one aspect, the voice data may be collected by capturing speech patterns rather than recording vocal snippets. Put another way, the phone application can capture speech patterns without recording a user's conversations (i.e. their phone calls). The data may be accumulated and used to identify whether the user is overly intoxicated individuals via statistical tools and algorithms. In one aspect, the data may be accumulated into a statistical distribution (i.e. a parameterized mathematical function). In one aspect, each type of data can be accumulated into its own statistical distribution. In one aspect, all data may be accumulated together into a single statistical distribution. The overly intoxicated determination may be made through one or more algorithms running in the background either while the user device is on or while the phone application is active. The algorithms can be configured to identify probabilities associated with over intoxication.

In one aspect, the phrases selected as the baseline for voice recognition and for the overly intoxicated determination may be based on language and known word or terms that are commonly wrongly annunciated by overly intoxicated individuals. Police forces around the world have worked with linguists and speech therapists to identify phrases and words that are more difficult to pronounce when intoxicated. For example, the phrase “seven seven” combines words that start with s, which are easily slurred. Utilizing multiple words that are difficult to pronounce when intoxicated may cause additional speed and clarity issues that may contribute to an overly intoxicated determination.

In one aspect, the cognitive tests can utilize cognitive questions that have answers that are more likely to be slurred. The cognitive data and voice data may be combined and analyzed against the user's baseline cognitive response to make an overly intoxicated determination.

In one aspect, the overly intoxicated determination can be made utilizing artificial intelligence (“AI”) or machine learning. The machine learning algorithm may be supervised or unsupervised. For example, the overly intoxicated determination can be made by utilizing a clustering algorithm (such as k-means clustering) to determine whether the user's current behavior is outside of what is expected for that user. The user's verbal response time and speech characteristics can be used to identify overly intoxicated individuals using statistical tools and algorithms, such as those described above.

In one aspect, when the restricted product delivery system is undermanned, the one or more supervising people present may assist in the overly intoxicated determination.

In one aspect, the phone application can be automatically populated with the information on the identification presented during registration.

In order to purchase a product from the delivery unit, the user can scan a code on the machine using the user device (i.e. the camera on a cell phone), which may launch a phone application if the user already has the phone application installed. If the user does not have the phone application installed, scanning the code may initiate a download of the phone application. In the phone application, the user can see a list of products available for purchase from the delivery unit. The user may then select the products they wish to purchase. In one aspect, the user can move to the next phase of the process by selecting a checkout option. The system may then complete a number of validations. The user's identity, eligibility, and ability to purchase may be determined through any of the methods described throughout the specification.

In one aspect, the system can determine whether the user is actually present at the delivery unit. This location determination may reduce the risk that the delivery unit makes a product available to a person based on a remote verification of another person. Put another way, the location determination may help ensure that the user who is verified by the system is the person who is present to receive the product. This determination may utilize the location of the delivery unit (i.e. through the global positioning system (“GPS”)) and compare it to a cell tower ping of the user device to determine whether the user device is proximate to the delivery unit. In one aspect, the delivery unit can have a cell phone chip. The delivery unit may ping the user device to verify the user device and the delivery unit are present at the same location. In one aspect, the user device can ping the delivery unit to verify that the delivery unit and the user device are present at the same location. In one aspect, the external server may ping both the delivery unit and the user device to determine whether they are in the same location. In one aspect, the location determination may utilize a geofence via a communication protocol (such as BLUETOOTH) between the user device and the delivery unit. In one aspect, the location determination may utilize a geofence via WiFi in combination with a QR code on the user device presented to the delivery unit. In one aspect, the system can validate the user's ability to pay for the selected products and may charge the user's payment method for the products. In one aspect, payment may be made directly from the phone application. In one aspect, payment may be made by the external server or a third-party application. Once the user's identity, eligibility, and ability to purchase have been verified, the delivery unit can provide access to the selected products(s).

In one aspect, the restricted product delivery system can be configured to integrate with any database. For example, the restricted product delivery system may tie into a state, federal, or foreign government database to access any restrictions and to report back any transactions that have to be tracked by law. One example of this is the National Precursor Log Exchange (“NPLEx”). To sell many different types of OTC drugs (such as those containing the precursor pseudoephedrine) the seller has to verify the person is old enough to purchase and check the database to make sure the person has not exceeded their monthly volume of the product they can purchase. Once the person is verified, the seller may sell the person can the product and the seller has to report back to NPLEx what they sold to the person and the date. Many OTC drugs can contain the same precursor and the amount of the precursor purchased (i.e. in milligrams) is often what has to be reported by regulation. The restricted product delivery system may be used to perform this process. The restricted product delivery system can tie into a government system to verify the user is eligible to purchase the product based on their age. The restricted product system may be connected to the NPLEx to determine whether the user is eligible to purchase a selected product based on the volume they have previously purchased within a given time frame.

In one aspect, the restricted product delivery system may be configured to track and provide control approvals based on unique identities and specific requirements for restricted products. For example, employers may prevent their employees from purchasing alcohol and cannabis on the worksite.

In one aspect, where the delivery unit is a vending machine, the delivery unit may include a controller and a label printer. Certain restricted products may have to be labelled by regulation. The label may include the date the restricted product was purchased, the time the restricted product was purchased, and/or the location at which it was sold. In one aspect, the label may include the name and location of the delivery unit that sold the restricted product. In one aspect, the label can include a code provided by a third party database (i.e. a government database) that tracks how much product is sold to each person individually. In one aspect, the label may be appended to the product by the delivery unit injecting the label onto the packaging. In one aspect, the label can be printed and applied to the packaging of the product.

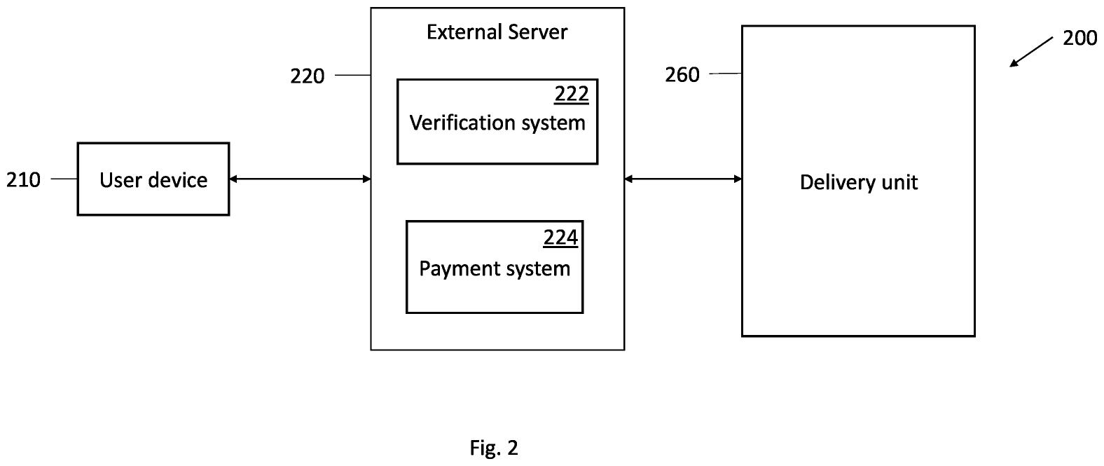

FIG. 2 shows a restricted product delivery system 200 according to one aspect. The restricted product delivery system 200 can include a user device 210, an external server 220, and a delivery unit 260. The external server 220 may be communicatively coupled to the user device 210 and the delivery unit 260. In an alternate aspect, the user device 210 can be communicatively coupled to the external server 220 and the delivery unit 260. In yet another aspect, the delivery unit 260 may be communicatively coupled to the user device 210 and the external server 220. The communicative coupling can be direct or indirect. As shown in FIG. 2, the external server 220 may include a verification system 222 and a payment system 224. The verification system 222 can verify the user's identity. The payment system 224 may verify the user's payment method and that the user has sufficient funds for the selected product(s). In one aspect, the determination of whether the user has sufficient funds may be referred to as a payment determination. In one aspect, the verification system 222 and the payment system 224 can be incorporated into one system. In one aspect, the external server 220 may communicate with a third-party system for at least one of the verification system 222 and the payment system 224. In one aspect, at least one of the verification system 222 and the payment system 224 can be external to the restricted product delivery system 200.

The verification system may authenticate a prospective purchaser using a touchless biometric scanning of, for example, face, eyes, or retina scans, the prospective purchaser. The touchless biometric scanning may be completed by the delivery unit or the user device. In one aspect, the verification system can utilize a touch based biometric scan, such as a fingerprint or palm scan, through the user device. In this way, the prospective purchaser does not have to touch the delivery unit to provide their biometric information. The biometric information may be communicated to the external server through any suitable means, for example, through the Internet. The external server can verify the person's information in a database. Put another way, the external server can determine whether the prospective purchaser is who they claim to be. In one aspect, the external server may be incorporated into the delivery unit. In an alternate aspect, the external server can be incorporated into the user device.

Once the prospective purchaser has been verified, software on the external server may determine that the prospective purchaser is eligible to purchase their selected product. Eligibility can be based on a variety of different criteria depending on the restrictions placed on the selected product. For example, each person can only purchase so many milligrams of medicine containing pseudoephedrine in a month. In another example, a person can only purchase alcohol if they are 21 years old or older. Once the external server has determined that the prospective purchaser is eligible to purchase the selected product, the delivery unit can release the selected product to the user. In one aspect, the external server may communicate the user's eligibility to the user device and the user device may communicate their eligibility to the delivery unit. In one aspect, the external server can communicate the user's eligibility directly to the delivery unit. If the delivery unit is a vending machine, the delivery unit can vend the product for the user to collect. If the delivery unit is a locker system, the delivery unit may open the door of the locker containing the selected item, or may provide the user with a code or other mechanism to open the appropriate locker when the user is present.

In one aspect, the system also determines whether the prospective purchaser has sufficient funds to purchase the selected product.

The verification system may also authenticate a user using multi-factor authentication. Any combination of two or more authentication methods can be used for this purpose. Some exemplary authentication methods in addition to the biometric methods previously described are listed below. One exemplary authentication method is authentication performed through a code sent to the user device. The code may be a QR code that can be held up to a scanner on the delivery unit, a pin that the user keys in to a user interface on the delivery unit, or any other suitable code. In another example, authentication can be performed using a credit card. The credit card may be swiped, inserted into the machine, tapped on an RFID reader, or scanned using a scanner on the delivery unit. In another example, authentication can be performed using a driver's license inserted into the delivery unit or scanned by the delivery unit and read. In yet another example, authentication may be done through a verification from a cell phone provider that may be read by the delivery unit or entered into the delivery unit by the user. Many cell phones on the market have some sort of biometric identification built in. For these user devices, the user device may be certified as belonging to the particular user by their biometric information. The user device can be used at the point of purchase to verify the user by the user entering their biometrics before use. Put another way, the user device itself may be used to verify the user's identity. In another example, authentication can be performed by a secure server that provides an output that can be read by the delivery unit (such as a QR code or via BLUETOOTH). In another example, authentication can be performed by the cell phone manufacturer in any manner that can be confirmed by the delivery unit. In yet another example, a third-party authentication application can provide authentication through a time sensitive code (such as a QR code, a bar code, or an alpha numeric code).

In one aspect, in order to ensure the person using the delivery unit is the person who was authenticated, a verification is performed within a predefined geographic range of the delivery unit. This verification may alternately be referred to as a location determination.

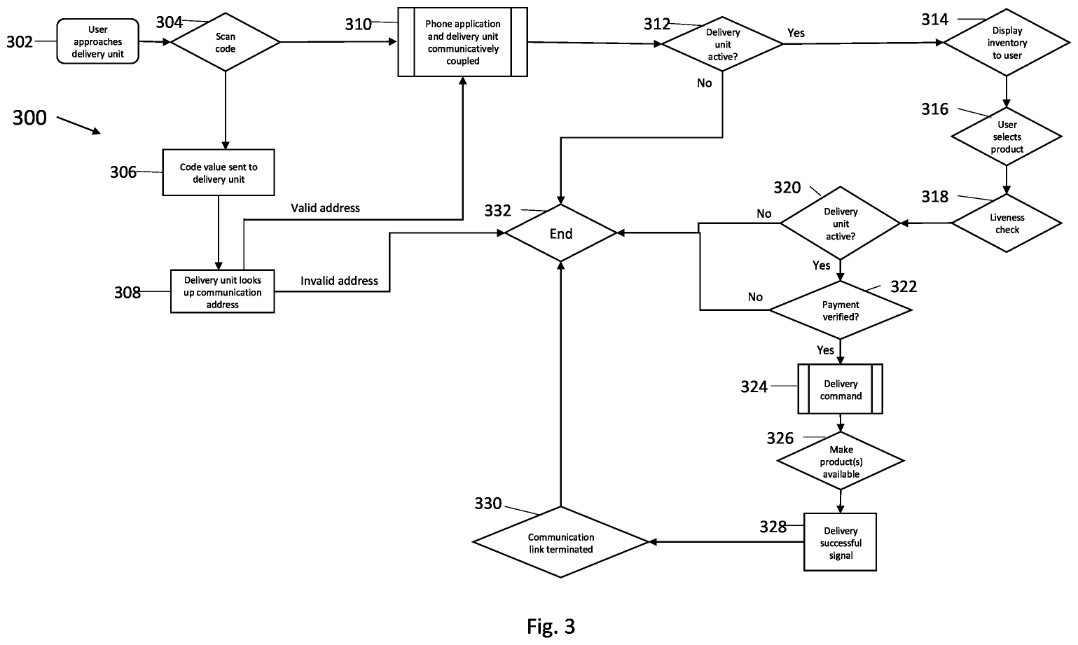

FIG. 3 shows a process for operating a restricted product delivery system 300 according to one aspect. The process 300 begins by a user approaching a delivery unit 302. The user may open a phone application on the user device and scan a code on the delivery unit from the phone application. Step 304. In one aspect, the code is a QR code. The code value can be sent to the provider of the delivery unit. Step 306. In one aspect, the code value may be sent to the delivery unit provider via a software development kit (“SDK”). The delivery unit provider can determine whether the code is a legitimate code. If the code is legitimate, the delivery unit provider can look up the communication address for the delivery unit (Step 308) and send the communication address to the phone application. In one aspect, the communication may occur via BLUETOOTH and the communication address may be a BLUETOOTH Low Energy (“BTLE”) address. If the code is not legitimate, the delivery unit provider may send a message to the phone application to indicate that the delivery unit is not valid and the phone application may proceed to Step 332 where the process 300 ends.

The phone application can be communicatively coupled to the delivery unit. Step 310. The delivery unit may have a controller through which the delivery unit communicates to the phone application of the user device. The phone application may check to see if the delivery unit is active. Step 312. In one aspect, the delivery unit may be inactive because the current time is outside of the operating hours for this delivery unit. The operating hours can be determined by the operator or may be dictated by regulations for the products available through the delivery unit. If the delivery unit is not active, the process 300 proceeds to Step 322 and ends, thereby terminating the communication link between the phone application and the delivery unit. In one aspect, the phone application may display a notification to the user indicating that the delivery unit is not currently active. If the delivery unit is active, the phone application can present a catalog of the products available at the delivery unit. Step 314. The user may then select one or more products they would like to purchase. Step 316. The phone application can perform a liveness check to determine whether the user is actually present at the delivery unit. Step 318. For example, the liveness check can determine that the user is presenting themselves to the device rather than presenting a picture of themselves. In one aspect, the liveness check may involve analyzing the image or video of the user to determine they are real, for example, through motion or texture detection. In one aspect, the liveness check may utilize artificial intelligence. In one aspect, the phone application can make a location determination simultaneous with or substantially at the same time as the liveness check. The location determination may help ensure the person is present within a predefined geographic range of the delivery unit.

The phone application can utilize biometrics to verify the identity of the user. When the user is registering for the phone application, the phone application may be in communication with an external server for biometric authentication. In one aspect, the phone application or the external server may communicate with a third-party database to perform the biometric authentication. In one aspect, the third-party database may be an identification database. When the user is verifying their identity at the time of a purchase, the phone application can perform the biometric verification. In an alternate aspect, the phone application can communicate with the external server to perform the biometric authentication at the time of the purchase. The use of biometrics is described in more detail below. The phone application may then check again to determine whether the delivery unit is active. Step 320. If the delivery unit is inactive, the phone application may proceed to Step 332 and the process 300 ends. If the delivery unit is active, the phone application can perform payment verification. Step 322. In one aspect, the phone application may communicate with an external server to verify the user's payment method. If the payment is not verified, the phone application may proceed to Step 322 and the process 300 ends. If the payment is verified the phone application can send a signal to the delivery unit to make the selected products available. Step 324. In one aspect, the phone application may send the specific location within the delivery unit from which the delivery unit should release the product. In one aspect, the phone application may send the delivery unit the type and quantity of the purchased product(s) and the delivery unit may decide from which location(s) to release the purchased product(s). At Step 326, the delivery unit can make the purchased products available to the user. In one aspect, if the user selects more than one product (either in quantity or in type of product), the delivery unit may release all the products at once. In one aspect, if the user selects more than one product, the delivery unit may release the products one at a time. In this case, the phone application can check whether the delivery unit is still active between each release.

After the delivery unit releases the product, the delivery unit may send a signal to the phone application that the product delivery was successful. Step 328. The communication link between the delivery unit and the phone application may be terminated. Step 330. The process 300 may then end. Step 332.

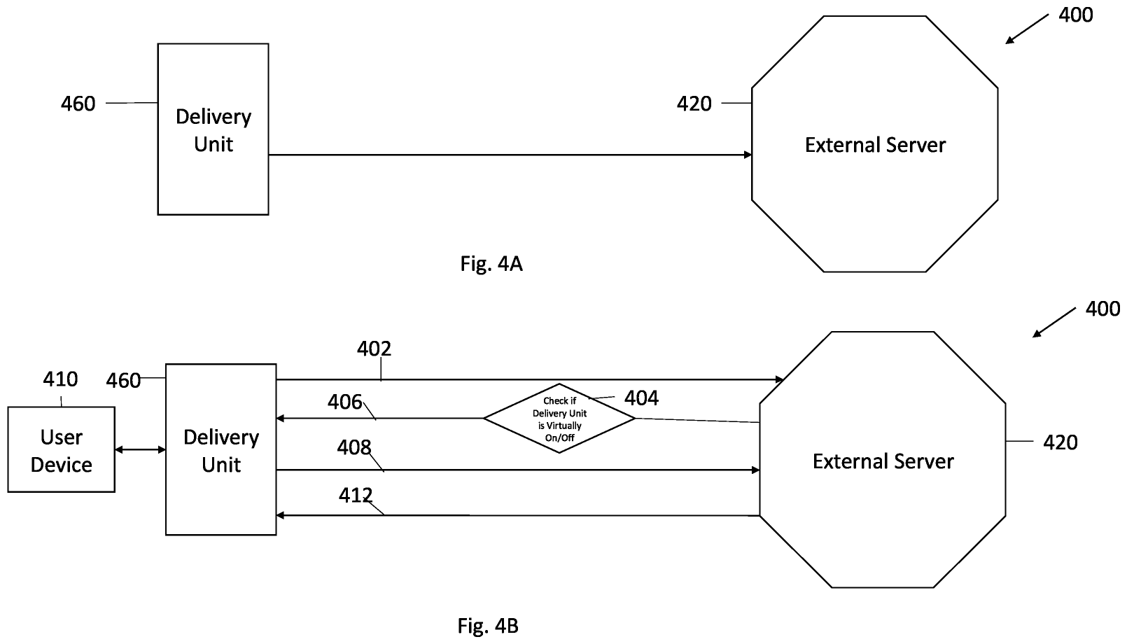

FIGS. 4A-4B show a portion of a restricted product delivery system 400 according to one aspect. FIGS. 4A-4B show the communication between an external server 420 and a delivery unit 460 in two different scenarios. In FIG. 4A, the communication between the external server 420 and the delivery unit 460 to establish the connection between the external server and the delivery unit 460 is shown. In the depicted configuration the delivery unit 460 sends a signal to the external server 420 to indicate that it is active. In one aspect, this can be done via a heartbeat signal such as an Approval and Charge. For example, the delivery unit 460 may send a signal to the external server 420 every five minutes to indicate to the user device that the delivery unit 460 is turned on and to provide a piece of information, such as the temperature of the delivery unit 460. In an alternate aspect, the external server 420 may send a signal to the delivery unit 460 to determine whether it is active.

In FIG. 4B an exemplary exchange of signals between the delivery unit 460 and the external server 420 when the user device 410 sends a delivery command to the delivery unit 460 is shown. At 402, the delivery unit 460 may send the delivery command, a portion of the information included in the delivery command, or a signal representing the delivery command to the external server 420. If the external server 420 determines the delivery command is legitimate, the external server 420 can check whether the delivery unit 460 is virtually on. Step 404. If the delivery unit 460 is virtually off, the external server 420 may turn the delivery unit 460 on. Once the delivery unit 460 is virtually on, the external server 420 may send a response 406 to the delivery unit 460. The response 406 can tell the delivery unit 460 which product(s) to provide access to. At 408, the delivery unit 460 can send a signal to the external server 420 that indicates the products have been made available to the user. In one aspect, this may be done by the delivery unit 460 posting a ChargeID to be received by the external server 420. In one aspect, the external server can then charge the user's payment method for the products. At 412, the external server 420 may send a response to indicate this transaction is complete and that the delivery unit 460 may proceed to the next delivery command.

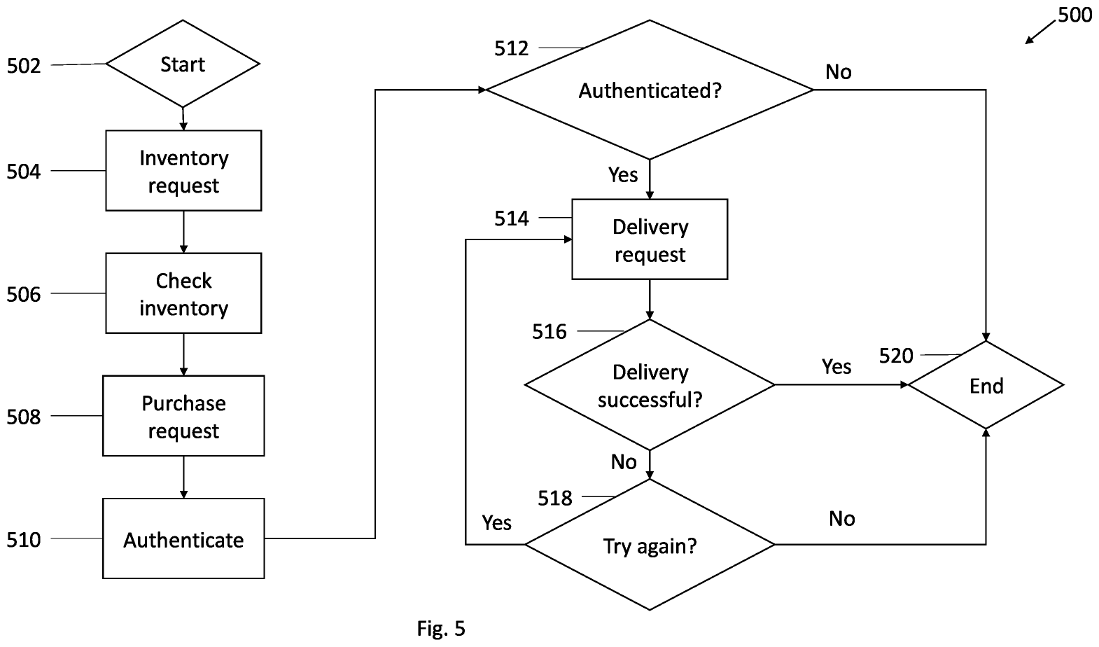

FIG. 5 shows a process for restricted product delivery 500 according to one aspect. The process may start at Step 502. The user device may send an inventory request. Step 504. In one aspect, the user device may send the inventory request to the external server. In one aspect, the user device can send the inventory request to the delivery unit, either directly or to the external server. The external server or delivery unit may check the inventory of the delivery unit. Step 506. In one aspect, the inventory can be stored on the delivery unit. In one aspect, the inventory may be stored remote from the delivery unit. The user may select one or more products to purchase from the inventory. The user device can send the purchase request to the external server or the delivery unit. Step 508. The user may then be authenticated. In one aspect, the authentication may include identity verification, eligibility verification, and payment verification. The authentication can be performed using the methods outlined throughout the specification. At step 512, the external server may determine whether the user is authenticated. If the user is not authenticated, the process 500 can proceed to Step 520 and the process ends. If the user is authenticated, the external server may send a delivery request to the delivery unit. Step 514. The external server may check whether the delivery was successful. Step 516. If the delivery was successful, the process 500 can proceed to Step 520 and the process ends. If the delivery was unsuccessful, the external server may decide whether to try delivery again. In one aspect, the external server can make this determination independent of outside input. In one aspect, the external server may alert the user through the user device that the delivery was unsuccessful and allow the user to input whether to try delivery again. If the external server determines not to try delivery again, the process 500 may proceed to Step 520 and the process ends. If the external server determines to retry delivery, the process 500 returns to Step 514 and proceeds as described above.

In one aspect, the delivery system for restricted products may operate as follows. Individual users can register for identity verification through a phone application used in the system or through a third-party service. The identity verification may utilize any of the verification methods described throughout the specification. The user's information may be stored on an external server. A product provider can load products into the delivery unit for purchase by a user. In one aspect, the product provider is a prescriber and the product loaded into the delivery unit is a prescription. The product provider may communicate the products, their quantities, and the location of the delivery unit to the external server. In one aspect, this information may be uploaded to a data management system.

A user may approach the delivery unit and scan a code on the delivery unit through the user device. In one aspect, the delivery unit can include a scanner and may scan the user device or the user's biometrics to provide the user with access to the delivery unit. The products available at the delivery unit may be displayed on the user device. A user can select an item to purchase through the phone application. In one aspect, the user's product selection may be done through a voice command. The phone application may verify the user is who they purport to be and the user is eligible to purchase the selected product. In one aspect, the user's prescriptions can be programmed into the system. In one aspect, national laws, regional laws, state laws, district laws, and city laws may be programmed into the system. The verification process can check the user's characteristics against the laws to determine whether the user is eligible to purchase. In one aspect, the eligibility determination can include an evaluation of the user's purchase history across one or more delivery units to determine whether this purchase will exceed the user's purchase limit. The eligibility determination may also include a payment verification. Once the user has been deemed eligible to purchase, a payment may be requested and payment may be received to allow access to the product. Payment may be made through any suitable payment method. In one aspect, the payment verification can be separate verification step in which case the delivery unit may not provide access to the product until both eligibility and payment ability have been confirmed. Once the user has been deemed eligible, the delivery unit can then provide access to the product.

In one aspect, the restricted product delivery system can include a biometric screening or identification at the delivery unit. Additionally, or alternatively, the restricted product delivery system may conduct identity verification through a cloud-based server or a standalone remote server via the Internet. The restricted product delivery system can transmit data via BLUETOOTH, WiFi, wired connection to router and/or any other suitable communication system that allows for Internet connection. In one aspect, the system may communicate without using the Internet.

Biometric identification can include facial recognition, fingerprint, retina scan, or any like system. In order to verify a person's identity at the delivery unit, the person's biometric identifiers may be authenticated and/or registered prior to use of the delivery unit and the biometric identifiers may be stored. In one aspect, the biometric identifiers can be stored at a location remote form the user's device, such as a cloud based or standalone server system. Additionally, or alternatively, the biometric identifiers may be stored on the user's device. In one aspect, the delivery unit itself can store the biometric identifiers. An exemplary biometric service provider is CLEAR.

In one aspect, a user may be able to create a profile that is stored on the external server. In one aspect, a portion of the profile may be cached on the user device. The profile can store the user's authentication data. The user may be able to upload access documents to their profile. Access documents can include, but is not limited to, prescriptions and medical marijuana cards. By storing the user's access documents in their profile, the user can utilize any delivery unit to procure the authorized items. In one aspect, the system may store indicators of the user's access documents rather than store copies of the user's access documents.

In one aspect, a restricted product delivery system can be used to reduce staffing costs. In a fully unmanned system, the restricted product delivery system may only utilize outside interaction to function when the delivery unit is being stocked. In many cases, this may be via a person but it could also be done through an unmanned system. The restricted product delivery system may be available for purchase whenever legally permissible and therefore can allow a business to reduce its staffing costs by reducing its staffed hours.

In one aspect, a payment system may be included in the verification system. A user may link a payment method to their account during the verification process. The payment method can include a credit card, debit card, APPLE PAY, GOOGLE PAY, or any other suitable payment method. Transactions can then take place without the user having to have cash or card in hand. In an alternate aspect, the payment system can be separate from the verification system.

In one aspect, the delivery unit may be purchased or leased on a monthly subscription or yearly memberships. In one aspect, the restricted product delivery system may charge a percentage of the sale for the service or charge a percentage of the transaction to the credit card company.

In one aspect, the delivery unit can accumulate data on individual consumers or on consumers generally. For example, the delivery unit may collect consumption data regarding the type of products purchased, how much product is purchased, or any other suitable factor. Additionally, or alternatively, the delivery unit can collect data on buying patterns, travel patterns, credit card preferences, discretionary income, and/or any other aspect associated with the transactions. The accumulated data can be used for various applications. For example, the accumulated data may be used to predict the demand for a particular item and alert the stocking entity to stock the machine accordingly. In another example, the accumulated data may be used for product development and/or marketing. In one aspect, the external server may perform the data collection described above. In an alternate aspect, the user device can perform the data collection described above. In yet another aspect, the data collection may be done with any combination of the delivery unit, the external server, and the user device either redundantly or with a portion of the data collection being done by any combination of the delivery unit, the external server, and the user device.

In one aspect, the delivery unit may include an ultraviolet (“UV”) light in the dispensing area. The UV light can be used to kill bacteria and viruses in the dispensing area. In one aspect, the delivery curtain may have a light curtain that can sense when the product is removed from the dispensing area and signal the UV light to turn on.

In one aspect, the entire transaction may be video recorded. The video camera can be located on the delivery unit or off the delivery unit but pointed at the delivery unit. The video feed may be used to perform biometric verification of the user.

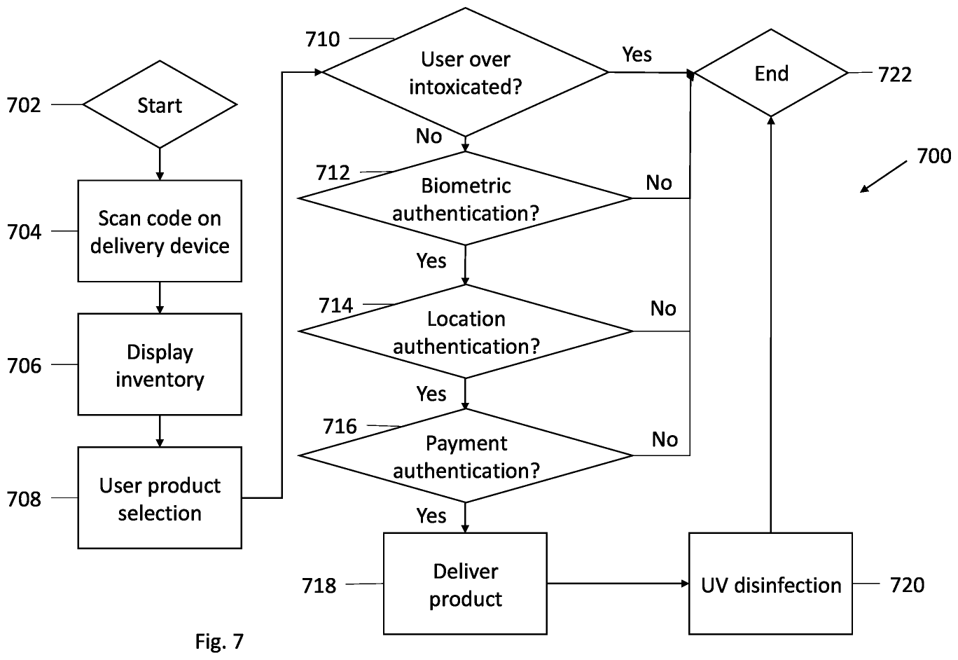

One exemplary purchasing process 700 is shown in FIG. 7. The process begins at Step 702. The user may scan a code on the delivery unit using the user device. Step 704. In one aspect, the code can be a QR code and the user may scan it by opening the camera on their user device and pointing it at the QR code. The user device may display the inventory of the delivery unit. Step 706. This may be done through the phone application. In one aspect, the inventory can be displayed using a browser on the user device. The user can select one or more products they wish to purchase. Step 708. In one aspect, the user may have to select checkout to move on to Step 710. The phone application can determine whether the user is overly intoxicated as described above. Step 710. If the phone application determines the user is overly intoxicated, the process can move to Step 722 and the process ends. In one aspect, the phone application may display an error message indicating the user cannot purchase the one or more selected products because the user has been determined to be overly intoxicated. If the phone application determines the user is not overly intoxicated, the phone application can perform biometric authentication of the user using any of the methods identified throughout the specification. Step 712. If the user does not verify their biometrics, the phone application may proceed to Step 722 and the process ends. The user device may determine whether the authenticated user is present at the delivery unit using location data. Step 714. If the user device determines that the authenticated user is not present at the delivery unit, the user device can proceed to Step 722 and the process ends. The user device can process payment for the selected products. Step 716. If payment is unsuccessful, the user device may proceed to Step 722 and the process ends. If payment is successful, the user device may send a signal to the delivery unit to provide access to the purchased product. The delivery unit may then provide access to the product. Step 718. After the used removes the product, the delivery unit can turn on a UV light pointed at the product retrieval area for a time to disinfect the area. Step 720. The process then proceeds to Step 722 and ends.

In one aspect, the phone application can perform a variety of other features for the users. In one aspect, the phone application may locate delivery units within a certain geographic range of the user device. In one aspect, the phone application can display the inventory of a delivery unit remotely. The phone application may also allow the user to purchase the products from a remote location and delay access until the user is proximate to the delivery unit. In one aspect, the phone application can allow a user to place a hold on a product for a predetermined period of time while the user travels to the delivery unit. In one aspect, the user may be charged an additional fee for placing a product on hold. In another aspect, the user can be charged a fee for failing to pick up the product while it was placed on hold.

In one aspect, the phone application can have a variety of features for vendors or distributors. In one aspect, the phone application may offer vendors the ability to change pricing for each product in each machine remotely. In one aspect, the phone application can offer vendors the ability to change the pricing dynamically. For example, the vendor may set a condition where if 90% of the inventory in the delivery unit is sold, the price of all items goes up 10%. In one aspect, the phone application can offer vendors the ability to update the delivery unit's inventory while on the site of the delivery unit. For example, a vendor may be able to update the amount of each product available at the delivery unit, the types of product being sold, and the pricing for the items. In one aspect, the phone application can provide real time sales information to the vendor. The vendor may use real time sales information for inventory tracking, determining the popularity of an item, or any other suitable purpose. In one aspect, the phone application may use RFID, QR codes, or bar codes to track sales and inventory. This may or may not include codes on each individual product. In one aspect, the phone application can utilize biometrics, location data, and/or video monitoring of the delivery unit to restrict access to the delivery units and their respective inventory management to certain users.

In one aspect, the system may be configured for use with any restriction system. For example, a pseudoephedrine registry or a firearm registry.

In one aspect, the system can deny a purchase based on the presented identification being inauthentic. For example, if a falsified identification is presented to the system, the system may check the identification against a third party identification database, determine that the identification is not legitimate, and identify the user as ineligible to purchase the selected product(s) or to register for the system.

Some exemplary use cases for the restricted product delivery system are now described. The restricted product delivery system can be configured for any regulated or otherwise restricted product. The restricted product delivery system may be used in grocery stores, drug stores, malls, or any suitable location that would be compliant with the applicable laws.

The restricted product delivery system may be used to vend alcohol. The restricted product delivery system can verify the age of the would-be customer to determine whether they are of legal drinking age. For example, such a system can be located on a golf course to dispense beer and mixed drinks away from the supervision of the golf course staff and without involvement by the staff. In some applications, a restricted product delivery system for alcohol may also verify whether the would-be customer has exceeded a quantified consumption limit. For example, a verified vending machine for alcohol in a sports stadium can be configured to only allow each customer to purchase a maximum of six alcoholic beverages during the duration of the event. In one aspect, the type of alcoholic beverage may factor in to the quantified consumption limit. For example, each customer can purchase eight “points” of alcohol and a glass of wine and single shot liquor beverage are two points while a bottle of beer is one point. In one aspect, the delivery unit may open the alcoholic beverage before allowing the consumer to access it.

The restricted product delivery system can be used to vend tobacco products. The restricted product delivery system may verify the age of the would-be consumer to determine whether they are old enough to purchase tobacco. For example, a restricted product delivery system for tobacco may be used in a grocery store and may eliminate an extra counter used to help verify a prospective customer's age.

The restricted product delivery system can be used to vend cannabis products. In places where cannabis has been legalized for recreational use, the restricted product delivery system may verify the age of a prospective consumer. The delivery unit for cannabis can be placed outside a dispensary to allow purchases outside of dispensary hours and reduce the dispensary's staffing costs. In places where cannabis is only legalized for medical use, the restricted product delivery system may verify the prospective consumer's medical marijuana card or prescription. For example, a restricted product delivery system for marijuana can be used in a bar, resort lobby, or grocery store.

The restricted product delivery system may be used to vend prescription drugs. The restricted product delivery system may verify a prospective consumer's identity and prescription. For example, the delivery unit can be placed in a pharmacy. A pharmacist may fill a person's prescription and place it in the delivery unit. The person may then pick up their prescription from the delivery unit outside of the pharmacy's hours and/or without having to interact face-to-face with the pharmacist.

In one aspect, a restricted product delivery system for prescription drugs may be utilized by an insurance company. Insurance companies lose a great deal of interest income due to the way big box pharmacies process prescriptions. Prescriptions are invoiced and paid for the minute a pharmacist fills a prescription rather than when the person picks up the prescription. Many pharmacies invoice the insurance company and get paid immediately (before the customer picks up their prescription). If the customer does not pick up the prescription, the pharmacy may not return it to the shelf for 10 to 20 days. In this way, the pharmacy may hold the insurance company's money and make interest on it even though the product was never actually sold because it was never picked up. Interest accrued based on present and future value of the money can be a significant loss in revenue for an insurance company. If an insurance company utilized a restricted product delivery system, it could know when a prescription is filled (paid for by them) and also when a customer picks up the prescription. In one aspect, the restricted product delivery system may be configured so that the insurance company does not pay for the prescription until it is picked up by the user. In one aspect, the restricted product delivery system can be configured to send at least one reminder to the user to pick up their prescription, which may result in more prescriptions being picked up and fewer losses to the insurance company as a result.

The restricted product delivery system can be used to vend restricted over-the-counter drugs, such as those which contain pseudoephedrine. In a location that limits the amount of such products that can be purchased in a given time period (such as one month), the restricted product delivery system may verify a prospective consumer's age and whether they may purchase the product and still be within the legal limit for the given time period. The purchase records may be maintained across multiple delivery units.

The restricted product delivery system can be used in gambling applications, such as electronic slot machines. Rather than touch the gambling machine (delivery unit) directly, the user may engage in the gambling services through the user device. This can reduce the costs of the business in which the machine is located because the machines are not being touched and therefore the frequency of sanitation can be reduced. The restricted product delivery system can verify a prospective gambler's age to determine they are eligible to access the gambling machine. The user device may then be used to access the gambling machine and cycle the machine. The external server or user device may track the person's available funds and winnings to check that the user is still eligible to use the machine after each cycle.

The restricted product delivery system can be used in a package retrieval service. The restricted product delivery system may verify the identity of the person present to retrieve the package to ensure the person present is eligible to pick up the package (i.e. they are either the person to whom the package is addressed or another person living at their address).

The above description is that of current aspects of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all aspects of the invention or to limit the scope of the claims to the specific elements illustrated or described in connection with these aspects. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed aspects include a plurality of features that are described in concert and that might cooperatively provide a collection of benefits. The present invention is not limited to only those aspects that include all of these features or that provide all of the stated benefits, except to the extent otherwise expressly set forth in the issued claims. Features of various aspects may be used in combination with features from other aspects. Directional terms, such as “vertical,” “horizontal,” “top,” “bottom,” “front,” “rear,” “upper,” “lower,” “inner,” “inwardly,” “outer,” “outwardly,” “forward,” and “rearward” are used to assist in describing the invention based on the orientation of the aspects shown in the illustrations. The use of directional terms should not be interpreted to limit the invention to any specific orientation(s). Any reference to claim elements in the singular, for example, using the articles “a,” “an,” “the,” or “said,” is not to be construed as limiting the element to the singular.

1. A delivery system for restricted products, comprising:
a user device, the user device including an input device and a user communication module, the input device configured to receive information from a user;
a delivery unit, the delivery unit containing at least one restricted product, the delivery unit including a restriction mechanism and a delivery communication module, the restriction mechanism configured to prevent access to at least one restricted product until a delivery command is received; and
an external server, the external server including a server communication module, the external server being communicatively coupled to the user device and the delivery unit,
wherein the external server communicates with the delivery unit to determine an inventory of the delivery unit and communicates the inventory to the user device,
wherein the user device receives a user input via the input device of at least one selected product from the inventory,
wherein the user device communicates the at least one selected product and a user identifier to the external server,
wherein the external server calculates a location determination of whether the user device is within a predefined geographic range of the delivery unit,
wherein the external server calculates a verification determination of the user's identity based on the user identifier and at least one pre-registered user characteristic,
wherein the external server calculates an eligibility determination of whether the user is eligible to purchase the selected product based on at least one characteristic of the at least one selected product and the user identifier,
wherein the external server calculates a payment determination of whether the user has a sufficient amount of funds to pay for the at least one selected product,
wherein the external server sends the delivery command to the delivery unit based on the location determination, the verification determination, the eligibility determination, and the payment determination, and
wherein, after receiving the delivery command, the delivery unit provides access to the at least one selected product.

2. The delivery system of claim 1, wherein the restricted products include at least one of a restricted good and a restricted service.

3. The delivery system of claim 1, wherein the delivery unit is a vending machine.

4. The delivery system of claim 1, wherein the user device and the external server are integrated into one component.

5. The delivery system of claim 1, wherein the user identifier includes a biometric information.

6. The delivery system of claim 5, wherein the biometric information includes at least one of a facial scan, a fingerprint scan, a palm scan, a retina scan, and an at least one vocal characteristic.

7. The delivery system of claim 1,
wherein the user device communicates a user device location to the external server,
wherein the delivery unit communicates a delivery unit location to the external server, and
wherein the external server calculates the location determination based on the user device location and the delivery unit location.

8. The delivery system of claim 1, wherein the external server calculates the location determination based on a communication network, wherein the user device and the delivery unit are both communicating on the communication network.

9. The delivery system of claim 1, comprising:
an identification database, the identification database communicatively coupled to the external server,
wherein the external server calculates the verification determination by communicating with the identification database.

10. The delivery system of claim 1, comprising:
a restriction database, the restriction database communicatively coupled to the external server,
wherein the external server calculates the eligibility determination by communicating with the identification database.

11. The delivery system of claim 1, wherein the delivery unit appends a label to at least one of the at least one selected products after receiving the delivery command and before providing access to the at least one selected product.

12. The delivery system of claim 11, wherein the label includes at least one of an access date, an access time, and an access location.

13. The delivery system of claim 1,
wherein the external server calculates an overly intoxicated determination based on the user identifier and at least one pre-registered user characteristic,
wherein the external server sends a delivery command to the delivery unit based on the overly intoxicated determination, the location determination, the verification determination, the eligibility determination, and the payment determination.

14. A method of registering for a delivery system for restricted products, the method comprising:
accessing a phone application from a user device;
capturing a front of an identification using the user device;
capturing a back of an identification using the user device;
sending the front of an identification and the back of an identification from the user device to an external server;
capturing at least one biometric information using the user device;
sending the at least one biometric information from the user device to the external server;
receiving a payment information from a user using the user device;
sending, by the user device, the payment information to the external server;
calculating, by the external server, a verified identity of the user based on at least one of the front of an identification, the back of an identification, the at least one biometric information, and the payment information; and
storing, by the external server, the verified identity of the user.

15. The method of claim 14, wherein the biometric information includes at least one of a facial scan, a fingerprint scan, a palm scan, a retina scan, and an at least one vocal characteristic.

16. The method of claim 14, wherein the external server calculates the verified identity through communication with an identification database.

17. The method of claim 14, comprising:
sending an error message from the external server to the user device if the verified identity could not be calculated; and
displaying the error message in the phone application using the user device.

18. A method of purchasing a restricted product from a delivery system for restricted products, the method comprising:
receiving, at an external server, an inventory from a delivery unit, wherein the delivery unit contains at least one restricted product, wherein the delivery unit includes a restriction mechanism, wherein the restriction mechanism is configured to prevent access to at least one restricted product until a delivery command is received;
receiving, at a user device, the inventory from the external server;
displaying, at the user device, the inventory from the external server;
receiving, at the user device, a selection of at least one restricted product from the inventory from a user;
sending, from the user device, the selection and a user identifier to the external server;
calculating, by the external server, a location determination of whether the user device is within a predefined geographic range of the delivery unit;
calculating, by the external server, a verification determination of the user's identity based on the user identifier and at least one pre-registered user characteristic;
calculating, by the external server, an eligibility determination of whether the user is eligible to purchase the selection based on at least one characteristic of the selection and the user identifier;
calculating, by the external server, a payment determination of whether the user has a sufficient amount of funds to pay for the at least one selected product;
sending, by the external server, the delivery command to the delivery unit based on the location determination, the verification determination, the eligibility determination, and the payment determination; and
providing access to the selection, by the delivery unit, after receiving the delivery command.

19. The method of claim 18, wherein the external server calculates the eligibility determination by communicating with a restriction database.

20. The method of claim 18, comprising: appending, by the delivery unit, a label to the selection after receiving the delivery command but before providing access to the selection.
